(19) United States
(12) Patent Application Publication
(10) Pub. No.: US 2008/0002593 A1
(43) Pub. Date: Jan. 3, 2008

(54) System and method for dropping slow connections during a multi-connection download

(76) Inventors: Jeffrey M. Achtermann, Austin, TX (US); Liliana Orozco, Del Valle, TX (US); Donald W. Thomas, Austin, TX (US); Brian G. Vassberg, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/479,831

(22) Filed: Jun. 30, 2006

(51) Int. Cl. H04J 1/16; H04B 7/212; H04J 3/22

(52) U.S. Cl. 370/252; 370/443; 370/468

(57) ABSTRACT

A method, system, and computer-usable medium for dropping slow connections during a multi-connection download. In a preferred embodiment of the present invention, a download manager establishes a predetermined number of connections between a client and a predetermined number of servers. The download manager sets a minimum threshold data transfer rate for the client for a particular connection and drops a first connection that is transferring data at a rate below the minimum threshold if an overall transfer rate of a download after dropping the first connection is greater than the predetermined number of connections times the minimum threshold data transfer rate.

### CROSS REFERENCE TO RELATED APPLICATIONS

The present application is related to the following co-pending U.S. patent applications: U.S. patent application Ser. No. 11/256,261 (Docket No. AUS920050797US1) filed on Oct. 21, 2005; U.S. patent application Ser. No. 11/256,260 (Docket No. AUS920050798US1) filed on Oct. 21, 2005; and U.S. patent application Ser. No. 11/256,259 (Docket No. AUS920050799US1) filed on Oct. 21, 2005. The above-mentioned patent applications are assigned to the assignee of the present invention and are incorporated herein by reference in their entirety.

### BACKGROUND OF THE INVENTION

1. Technical Field

The present invention relates in general to the field of data processing systems. More particularly, the present invention relates to the field of networked data processing systems. Still more particularly, the present invention relates to a system and method for dropping slow connections during a multi-connection download.

2. Description of the Related Art

The ability to support multi-connection downloads is a desirable feature to Internet users. A multi-connection download enables an Internet user to utilize multiple connections to download files such as documents, music, or video files. Often, it is desirable to drop slow connections and replace them with faster connections for more efficient downloading. Some know solutions in the prior art include: dropping a connection when the speed of that particular connection falls within a specified threshold and measuring the latency between the download client and the server to determine the connection's throughput. The prior art does not take into the consideration the cause of the slow connection. Therefore, there is a need for a system and method to address the aforementioned limitations of the prior art.

### SUMMARY OF THE INVENTION

The present invention includes a method, system, and computer-usable medium for dropping slow connections during a multi-connection download. In a preferred embodiment of the present invention, a download manager establishes a predetermined number of connections between a client and a predetermined number of servers. The download manager sets a minimum threshold data transfer rate for the client for a particular connection and drops a first connection that is transferring data at a rate below the minimum threshold if an overall transfer rate of a download after dropping the first connection is greater than the predetermined number of connections times the minimum threshold data transfer rate.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1 is a block diagram illustrating an exemplary network in which a preferred embodiment of the present invention may be implemented;

FIG. 2 is a block diagram depicting an exemplary data processing system in which a preferred embodiment of the present invention may be implemented; and

FIG. 3 is a high-level logical flowchart diagram illustrating an exemplary method for dropping slow connections during a multi-connection download according to a preferred embodiment of the present invention.

### DETAILED DESCRIPTION OF THE PREFERRED EMBODIMENT

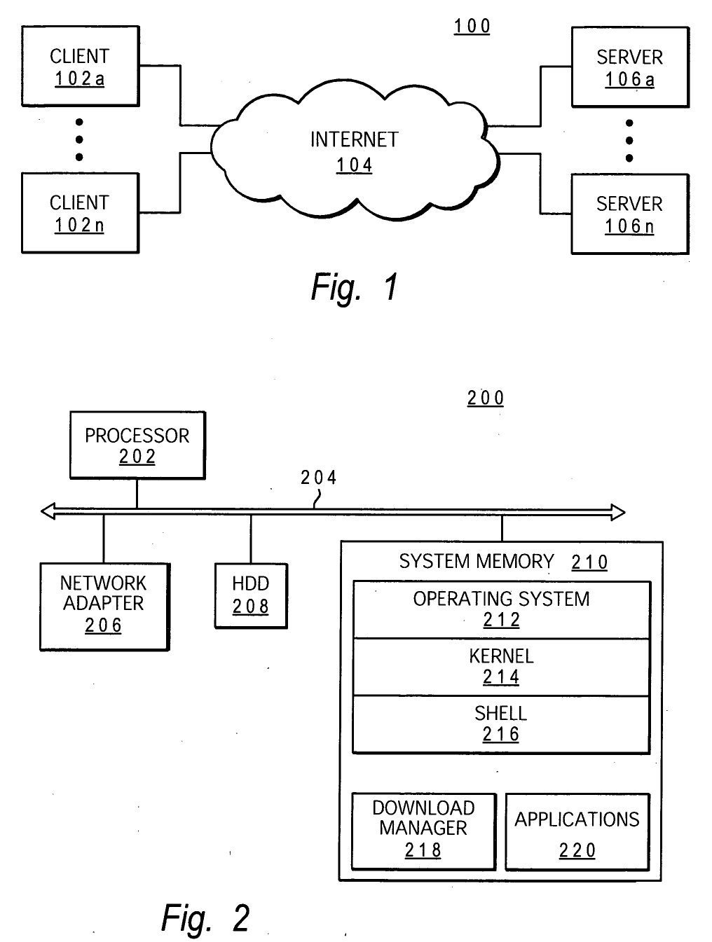

Referring now to the figures, and in particular, referring to FIG. 1, there is illustrated a block diagram depicting an exemplary network 100 in which a preferred embodiment of the present invention may be implemented. As illustrated, network 100 includes clients 102a-n, Internet 104, and servers 106a-n. In a preferred embodiment of the present invention, a client (e.g., client 102a) requests a multi-connection download of a file from any number of servers 106a-n and/or other clients 102a-n. Those with skill in the art will appreciate that Internet 104 may be implemented by any type of network from local-area networks (LANs) to wide-area networks (WAN) and may include wired (e.g., ethernet, etc.) or wireless (e.g., IEEE 802.11x, satellite, Bluetooth, etc.) connections.

Those skilled in the art will appreciate that network 100 can include many additional components not specifically illustrated in FIG. 1. Because sure additional components are not necessary for an understanding of the present invention, they are not illustrated in FIG. 1 or discussed further herein.

FIG. 2 is a block diagram illustrating an exemplary data processing system 200 which may be utilized to implement any of clients 102a-n and servers 102a-n as depicted in FIG. 1. As illustrated, data processing system 200 includes a processor 202 that is coupled to a network adapter 206, hard disk drive 208 and system memory 210 by a system interconnect 204.

Data processing system 200 couples to Internet 204 to connect to remote computers (e.g., servers 106a-n and/or other clients 102a-n) via network adapter 206. Network adapter 206 is preferably implemented as an Ethernet adapter, but those with skill in the art will appreciate that a wireless adapter utilizing IEEE 802.11x, telephone modem, or any other system utilized for accessing a network may be utilized. Hard disk drive 208 is utilized for high-capacity, non-volatile storage.

Preferably, system memory 112 may be implemented as a collection of dynamic random access memory (DRAM) modules. As illustrated, system memory 210 includes operating system 212, which further includes shell 216 for providing transparent user access to resources such as application programs 220. Generally, shell 216 is a program that provides an interpreter and an interface between the user and the operating system. More specifically, shell 216 executes commands that are entered into a command line user interface or a file. Thus, shell 216 (as it is called in UNIX®), also called a command processor in Windows®, is generally the highest level of the operating system software hierarchy and servers as a command interpreter. The shell provides a system prompt, interprets commands entered by keyboard, mouse, or other user input media, and sends the interpreted command(s) to the appropriate lower levels of the operating system (e.g., kernel 214) for processing. Note that while shell 216 is a text-based, line-oriented user interface, the present invention will support other user interface modes, such as graphical, voice, gestural, etc. equally well.

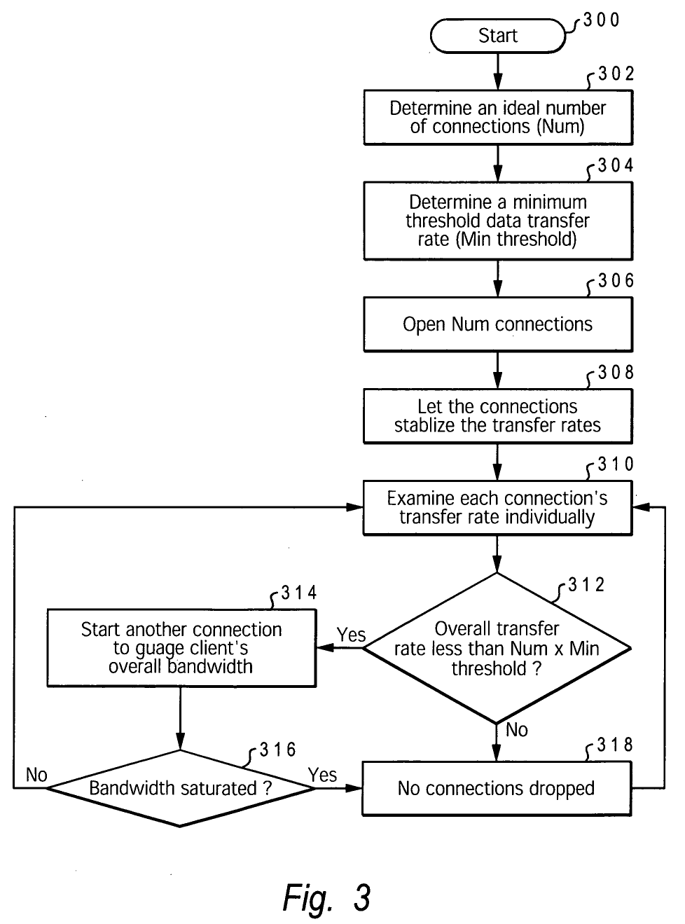

As illustrated, operating system 212 also includes kernel 214, which includes lower levels of functionality for operating system 212, including providing essential services required by other parts of operating system 212 and application programs 220, including memory management, process and task management, disk management, and mouse and keyboard management. Application programs 220 may include word processors, spreadsheets, and other application programs. Download manager 218 requests and manages multi-connection downloads, as discussed herein in more detail in conjunction with FIG. 3.

Those skilled in the art will appreciate that data processing system 200 can include many additional components not specifically illustrated in FIG. 2. Because sure additional components are not necessary for an understanding of the present invention, they are not illustrated in FIG. 2 or discussed further herein.

FIG. 3 is a high-level logical flowchart diagram illustrating an exemplary method for dropping slow connections during a multi-connection download according to a preferred embodiment of the present invention. The process begins at step 300 and proceeds to step 302, which illustrates a user interfacing with download manager 218 and specifying an ideal number of connections (Num). The process continues to step 304, which depicts the user interfacing with download manager 218 and specifying a minimum threshold data transfer rate (Min threshold). The process proceeds to step 306, which illustrates download manager 218 opening Num connections when downloading a file. Download manager 218 enables the connections to stabilize in transfer rate, as depicted in step 308, and examines each connection's transfer rate individually, as illustrated in step 310.

The process continues to step 312, which illustrates download manager 218 determining if the overall transfer rate is less than the ideal number of connections times the minimum threshold transfer rate. If the overall transfer rate is not less than the ideal number of connections times the minimum threshold transfer rate, the process continues to step 318, which illustrates download manager 218 maintaining all the current connections (i.e., does not drop any connections). The process returns to step 310 and proceeds in an iterative fashion.

Returning to step 312, if the overall transfer rate is less than the ideal number of connections times the minimum threshold transfer rate, the process continues to step 314, which illustrates download manager 218 starting an additional connection to gauge the client's overall bandwidth. If the bandwidth is determined to be saturated (i.e., the additional connection does not take up substantial additional bandwidth), the process continues to step 318 and proceeds in an iterative fashion. If the bandwidth is not saturated, the process returns to step 310 and proceeds in an iterative fashion.

For example, assume that download manager 218 determines three connections is the ideal number of initial connections. Download manager 218 starts three connections, and after their transfer rates stabilize, the individual transfer rates are gauged. Assume that the minimum threshold data transfer rate is set to 30 KB/s.

Also, assume that the individual transfer rates are:

connection 1: 800 KB/s

connection 2: 750 KB/s

connection 3: 20 KB/s

total transfer rate: 1570 KB/s

Since the total transfer rate (1570 KB/s) is greater than 3 (the initial number of connections) times 30 KB/s (the minimum threshold data transfer rate), any connection transferring at less than 30 KB/s is dropped by download manager 218. In this case, connection 3 (20 KB/s) is dropped.
However, in another example, assume that the transfer rates are:

connection 1: 28 KB/s

connection 2: 35 KB/s

connection 3: 20 KB/s

total transfer rate: 83 KB/s

Since the total transfer rate (83 KB/s) is less than 3 (number of initial connections) times 30 KB/s (the minimum threshold data transfer rate), no connection is dropped by download manager 218 regardless of the fact that some of the connections are transferring data at less than the minimum threshold.

As discussed, the present invention includes a method, system, and computer-usable medium for dropping slow connections during a multi-connection download. In a preferred embodiment of the present invention, a download manager establishes a predetermined number of connections between a client and a predetermined number of servers. The download manager sets a minimum threshold data transfer rate for the client for a particular connection and drops a first connection that is transferring data at a rate below the minimum threshold if an overall transfer rate of a download after dropping the first connection is greater than the predetermined number of connections times the minimum threshold data transfer rate.

It should be understood that at least some aspects of the present invention may alternatively be implemented in a computer-usable medium that contains a program product. Programs defining functions in the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory such as, but not limited to Random Access Memory (RAM), and communication media, such as computer and telephone networks, including Ethernet, the Internet, wireless networks, and like network systems. It should be understood, therefore, that such signal-bearing media when carrying or encoding computer readable instructions that direct method functions in the present invention represent alternative embodiments of the present invention. Further, it is understood that the present invention may be implemented by as a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention. Furthermore, as utilized in the specification and the appended claims, the term “computer” or “system” or “computer system” or “computing device” includes any data processing system including, but not limited to, personal computers, servers, workstations, network computers, main frame computers, routers, switches, personal digital assistants (PDAs), telephones, and any other system capable of processing, transmitting, receiving, capturing, and/or storing data.

What is claimed is:

1. A method of transferring data, comprising:
establishing a predetermined number of connections between a client and a predetermined number of servers;
setting a minimum threshold data transfer rate for said client for a particular connection; and
dropping a first connection that is transferring data at a rate below the minimum threshold, if an overall transfer rate of a download after dropping said first connection is greater than said predetermined number of connections times said minimum threshold data transfer rate.

2. The method according to claim 1, further comprising:
enabling said predetermined number of connections to stabilize in transfer rates.

3. The method according to claim 1, further comprising:
examining each connection among said predetermined number of connections individually.

4. The method according to claim 1, further comprising:
in response to determining said overall transfer rate of the download after dropping said first connection is not greater than said predetermined number of connections times said minimum threshold transfer rate, starting another connection to gauge said client's overall bandwidth.

5. The method according to claim 1, further comprising:
determining if said overall bandwidth is saturated.

6. A system comprising:
a processor;
a data bus coupled to said processor; and
a computer-readable medium embodying computer program code, said computer-usable medium being coupled to said data bus, said computer program code comprising instructions executable by said processor and configured for:
establishing a predetermined number of connections between a client and a predetermined number of servers;
setting a minimum threshold data transfer rate for said client for a particular connection; and
dropping a first connection that is transferring data at a rate below the
minimum threshold, if an overall transfer rate of a download after dropping said first connection is greater than said predetermined number of connections times said minimum threshold data transfer rate.

7. The system according to claim 6, wherein said instructions are further configured for:
enabling said predetermined number of connections to stabilize in transfer rates.

8. The system according to claim 6, wherein said instructions are further configured for:
examining each connection among said predetermined number of connections individually.

9. The system according to claim 6, wherein said instructions are further configured for:
in response to determining said overall transfer rate of the download after dropping said first connection is not greater than said predetermined number of connections times said minimum threshold transfer rate, starting another connection to gauge said client's overall bandwidth.

10. The system according to claim 6, wherein said instructions are further configured for:
determining if said overall bandwidth is saturated.

11. A computer-usable medium embodying computer program code, said computer program code comprising computer-executable instructions configured for:
establishing a predetermined number of connections between a client and a predetermined number of servers;
setting a minimum threshold data transfer rate for said client for a particular connection; and
dropping a first connection that is transferring data at a rate below the minimum threshold, if an overall transfer rate of a download after dropping said first connection is greater than said predetermined number of connections times said minimum threshold data transfer rate.

12. The computer-usable medium according to claim 11, wherein said embodied computer program code further comprises computer-executable instructions configured for:
enabling said predetermined number of connections to stabilize in transfer rates.

13. The computer-usable medium according to claim 11, wherein said embodied computer program code further comprises computer-executable instructions configured for:
examining each connection among said predetermined number of connections individually.

14. The computer-usable medium according to claim 11, wherein said embodied computer program code further comprises computer-executable instructions configured for:
in response to determining said overall transfer rate of the download after dropping said first connection is not greater than said predetermined number of connections times said minimum threshold transfer rate, starting another connection to gauge said client's overall bandwidth.

15. The computer-usable medium according to claim 11, wherein said embodied computer program code further comprises computer-executable instructions configured for:
determining if said overall bandwidth is saturated.
